(19) United States
(12) Patent Application Publication
(10) Pub. No.: US 2021/0277592 A1
(43) Pub. Date: Sep. 9, 2021

(54) METHODS AND COMPOSITIONS FOR MANUFACTURING LOW THERMAL CONDUCTIVITY TEXTILES

(71) Applicants: David Horinek, Camarillo, CA (US); Trenton Horinek, Ventura, CA (US)

(72) Inventors: David Horinek, Camarillo, CA (US); Trenton Horinek, Ventura, CA (US)

(21) Appl. No.: 17/191,577

(22) Filed: Mar. 3, 2021

Related U.S. Application Data
(60) Provisional application No. 62/984,711, filed on Mar. 3, 2020.

(51) Int. Cl. D06M 11/36; C01G 45/02; C09K 5/14; D01D 5/24

(52) U.S. Cl. CPC D06M 11/36; C01G 45/02; C09K 5/14; D10B 2401/04; C01P 2004/64; C01P 2004/62; D01D 5/24

(57) ABSTRACT

Disclosed herein is a method for producing low thermal conductivity fibers for manufacturing low thermal conductivity textiles, in accordance with some embodiments. Accordingly, the method may include a step of grinding manganese oxide into manganese oxide particles of a particle size ranging from 20 (nanometers) to 600 (nanometers). Further, the method may include a step of mixing the manganese oxide particles with an applicable substance for creating a masterbatch based on the grinding. Further, the masterbatch may include the manganese oxide particles in an amount ranging from 0.25% to 20% by weight of the masterbatch. Further, the method may include a step of applying the masterbatch to hollow fibers of a polymer based on the mixing. Further, the method may include a step of producing low thermal conductivity fibers based on the applying. Further, the low thermal conductivity textiles may be manufactured using the low thermal conductivity fibers.

The current application claims a priority to the U.S. provisional patent application Ser. No. 62/984,711 filed on Mar. 3, 2020.

### FIELD OF THE INVENTION

Generally, the present disclosure relates to the textiles. More specifically, the present disclosure relates to methods and compositions for manufacturing low thermal conductivity textiles.

### BACKGROUND OF THE INVENTION

The thermal conductivity of fabrics is important for designing clothing suitable for different climates. A fabric having a low thermal conductivity is most favorable in colder climates to prevent heat loss from the body. In warmer climates, a fabric with a higher thermal conductivity will allow heat to pass more easily from the body to help in cooling down the body.

Therefore, there is a need for improved methods and compositions for manufacturing low thermal conductivity textiles that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for producing low thermal conductivity fibers for manufacturing low thermal conductivity textiles, in accordance with some embodiments. Accordingly, the method may include a step of grinding manganese oxide into manganese oxide particles of a particle size ranging from 20 (nanometers) to 600 (nanometers). Further, the method may include a step of mixing the manganese oxide particles with an applicable substance for creating a masterbatch based on the grinding. Further, the masterbatch may include the manganese oxide particles in an amount ranging from 0.25% to 20% by weight of the masterbatch. Further, the method may include a step of applying the masterbatch to a plurality of hollow fibers of at least one polymer based on the mixing. Further, the method may include a step of producing a plurality of low thermal conductivity fibers based on the applying. Further, the low thermal conductivity textiles may be manufactured using the plurality of low thermal conductivity fibers.

Further disclosed herein is a low thermal conductivity fibers composition for manufacturing low thermal conductivity textiles, in accordance with some embodiments. Accordingly, the low thermal conductivity fibers composition may include manganese oxide particles, a masterbatch, and a plurality of hollow fibers. Further, the manganese oxide particles may be of a particle size ranging from 20 (nanometers) to 600 (nanometers). Further, the masterbatch may include the manganese oxide particles and an applicable substance. Further, the masterbatch may include the manganese oxide particles in an amount ranging from 0.25% to 20% by weight of the masterbatch. Further, the plurality of hollow fibers of at least one polymer.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a flowchart of a method for producing low thermal conductivity fibers for manufacturing low thermal conductivity textiles, in accordance with some embodiments.

FIG. 2 is a flowchart of a method for collecting first manganese oxide particles from the manganese oxide particles for producing the low thermal conductivity fibers, in accordance with some embodiments.

FIG. 3 is a flowchart of a method for collecting second manganese oxide particles from the manganese oxide particles for producing the low thermal conductivity fibers, in accordance with some embodiments.

FIG. 4 is a table listing ingredients of a low thermal conductivity fibers composition for manufacturing low thermal conductivity textiles, in accordance with some embodiments.

FIG. 5 is a flowchart of a method to facilitate manufacturing of a low thermal conductivity textile, in accordance with some embodiments.

FIG. 6 is a close-up view of a hollow fiber of the plurality of hollow fibers.

FIG. 7 illustrates a chart showing CLO Values from SGS for Heatlock Polar Fleece fabric, in accordance with some embodiments.

FIG. 8 is a perspective view of a container for plants comprising the low thermal conductivity textiles, in accordance with an exemplary embodiment.

FIG. 9 is a front view of a jacket comprising the low thermal conductivity textiles, in accordance with an exemplary embodiment.

FIG. 10 is a perspective view of a cigarette comprising the low thermal conductivity textiles, in accordance with an exemplary embodiment.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and compositions for manufacturing low thermal conductivity textiles, embodiments of the present disclosure are not limited to use only in this context.

### Overview

The present disclosure describes methods and compositions for manufacturing low thermal conductivity textiles. Further, a method to facilitate the manufacture of a low thermal conductivity textile is disclosed. Accordingly, the method may include a step of sourcing manganese oxide at small particles. Further, the small particles may be associated with a particle size of not greater than 1 micron. Further, the method may include a step of dry grinding the small particles of the manganese oxide. Further, the dry grinding may be a process of reducing particle size without using a liquid medium. Further, the method may include a step of wet grinding and converting it into a lump. Further, the wet grinding may be a process of making the material into a liquid form (slurry) and reducing particles, such as agglomerates by shearing them down in size ranging from 100 nm to 600 nm. Further, the method may include a step of capturing heat from a heat source. Further, the small particle size of the lump may facilitate capturing heat from the heat source. Further, the heat source may be the sun, a human body, or any ambient heat source. Further, the method may include a step of analyzing the lump to determine a D100. Further, the D100 may be associated with a size of 1 micron. Further, the method may include a step of choosing a polymer material. Further, the polymer material may include PET, cellulose, polylactic acid (PLA), Acrylic, Polypropylene, Nylon, Low-density polyethylene (LDPE), High-density polyethylene (HDPE), Polypropylene (PP), Polyvinyl chloride (PVC), Polystyrene (PS), Nylon, nylon 6, nylon 6,6, Teflon (Polytetrafluoroethylene), Thermoplastic polyurethanes (TPU), cellulose acetate (i.e. used in cigarette filters), etc. Further, the method may include a step of initiating a masterbatch process. Further, the masterbatch process may generate a masterbatch. Further, the masterbatch may be a concentrated mixture of pigments and/or functional particles encapsulated during a heat process into a carrier resin which is then cooled and cut into a granular shape. Further, the masterbatch may allow the processor to add functional reactive particles to raw polymers economically during the plastics manufacturing process. Further, the method may include a step of extruding the masterbatch into a hollow fiber membrane. Further, the hollow fiber membrane may be a class of artificial membranes containing a semi-permeable barrier in the form of a hollow fiber. During this process, the microparticles of manganese may be prevalent on the outside matrix of the hollow fiber creating a superior insulation matrix as air resides in the center of the hollow fiber and low conductive manganese oxide particles are on the outside of the hollow fiber.

The present disclosure describes methods to facilitate the fabrication of low thermal conductivity textiles. Further, the present disclosure relates to a concept of recreating an environment of stopping heat from moving through a substrate and absorbing heat from a known source, thereby creating heat with small amounts of ambient moisture.

By sorting through the periodic table and arranging the elements from the lowest thermal conductivity to the highest elements.

Thermal Conductivity of Elements

| | | | |
|---|---|---|---|
| Thermal Conductivity | Name | Symbol | # |

| | | | | |
|---|---|---|---|---|
| 0.0000364 | W/cmK | Radon | Rn | 86 |
| 0.0000569 | W/cmK | Xenon | Xe | 54 |
| 0.000089 | W/cmK | Chlorine | Cl | 17 |
| 0.0000949 | W/cmK | Krypton | Kr | 36 |
| 0.0001772 | W/cmK | Argon | Ar | 18 |
| 0.0002598 | W/cmK | Nitrogen | N | 7 |
| 0.0002674 | W/cmK | Oxygen | O | 8 |
| 0.000279 | W/cmK | Fluorine | F | 9 |
| 0.000493 | W/cmK | Neon | Ne | 10 |
| 0.00122 | W/cmK | Bromine | Br | 35 |
| 0.00152 | W/cmK | Helium | He | 2 |
| 0.001815 | W/cmK | Hydrogen | H | 1 |
| 0.00235 | W/cmK | Phosphorus | P | 15 |
| 0.00269 | W/cmK | Sulfur | S | 16 |
| 0.00449 | W/cmK | Iodine | I | 53 |
| 0.017 | W/cmK | Astatine | At | 85 |
| 0.0204 | W/cmK | Selenium | Se | 34 |
| 0.0235 | W/cmK | Tellurium | Te | 52 |
| 0.063 | W/cmK | Neptunium | Np | 93 |
| 0.0674 | W/cmK | Plutonium | Pu | 94 |
| 0.0782 | W/cmK | Manganese | Mn | 25 |
| 0.0787 | W/cmK | Bismuth | Bi | 83 |
| 0.0834 | W/cmK | Mercury | Hg | 80 |
| 0.1 | W/cmK | Americium | Am | 95 |
| 0.1 | W/cmK | Californium | Cf | 98 |
| 0.1 | W/cmK | Nobelium | No | 102 |
| 0.1 | W/cmK | Curium | Cm | 96 |
| 0.1 | W/cmK | Lawrencium | Lr | 103 |
| 0.1 | W/cmK | Fermium | Fm | 100 |
| 0.1 | W/cmK | Einsteinium | Es | 99 |
| 0.1 | W/cmK | Berkelium | Bk | 97 |
| 0.1 | W/cmK | Mendelevium | Md | 101 |
| 0.106 | W/cmK | Gadolinium | Gd | 64 |
| 0.107 | W/cmK | Dysprosium | Dy | 66 |
| 0.111 | W/cmK | Terbium | Tb | 65 |
| 0.114 | W/cmK | Cerium | Ce | 58 |
| 0.12 | W/cmK | Actinium | Ac | 89 |
| 0.125 | W/cmK | Praseodymium | Pr | 59 |
| 0.133 | W/cmK | Samarium | Sm | 62 |

Manganese and air were chosen. The molecules of two different elements, nitrogen and oxygen, make up about 99 percent of the air. The rest includes small amounts of argon and carbon dioxide. (Other gases such as neon, helium, and methane are present in trace amounts) Oxygen is the life-giving element in the air.

To describe the process of creating the low thermal conductive textile, we start with sourcing manganese oxide once. Manganese oxide is sourced at a particle size of not greater than 1 micron, we then dry grind wet grind to a specific size with ranges from 100 nm to 600 nm to optimize and capture heat from the emitting source be it the sun, human body, or ambient heat source. Thermal radiation is electromagnetic radiation emitted from all matter that is at a non-zero temperature in the wavelength range from 0.1 μm to 100 μm. It includes part of the ultraviolet (UV), and all of the visible and infrared (IR). Further, thermal radiation does not require a material medium for its propagation.

After analyzing the processed powder to determine a D100 of 1 micron and below the master batching process is then started. Masterbatch is a concentrated mixture of pigments and/or functional particles encapsulated during a heat process into a carrier resin which is then cooled and cut into a granular shape. Further, the masterbatch allows the processor to add functional reactive particles to raw polymers economically during the plastics manufacturing process. The polymers may be PET, Cellulose, polylactic acid or PLA, Acrylic, Polypropylene, Nylon, Low-density polyethylene (LDPE), High-density polyethylene (HDPE), Polypropylene (PP), Polyvinyl chloride (PVC), Polystyrene (PS), Nylon, nylon 6, nylon 6,6, Teflon (Polytetrafluoroethylene), Thermoplastic polyurethanes (TPU), cellulose acetate (i.e. used in cigarette filters), etc.

Once the polymer is chosen the masterbatch process is started depending on desired functionality the masterbatch could be loaded at a % of 1% to 20%. Once a known masterbatch has been made, the masterbatch is then extruded into a known hollow fiber. Hollow fiber membranes (HFMs) are a class of artificial membranes containing a semi-permeable barrier in the form of a hollow fiber. Originally developed in the 1960s for reverse osmosis applications, hollow fiber membranes have since become prevalent in water treatment, desalination, cell culture, medicine, and tissue engineering. Most commercial hollow fiber membranes are packed into cartridges which can be used for a variety of liquid and gaseous separations.

During this process, the microparticles of manganese will be prevalent on the outside matrix of the hollow fiber creating a superior insulation matrix as air resides in the center of the hollow fiber and Low Conductive Manganese oxide particles are on the outside of the hollow fiber.

Further, manganese nanoparticles between 20 nm-50 nm may be mixed with a known water-resistant coating with a ratio of 0.25-1%. This may be applied by spray coating or plasma deposition.

Plasma-enhanced chemical vapor deposition (PECVD) is a chemical vapor deposition process used to deposit thin films from a gas state (vapor) to a solid-state on a substrate. Chemical reactions are involved in the process, which occurs after the creation of a plasma of the reacting gases. The plasma is generally created by radio frequency (RF) (alternating current (AC)) frequency or direct current (DC) discharge between two electrodes, space between which is filled with the reacting gases.

The Low conductive hollow fibers have multiple uses one use is for keeping the body warm in cold weather situations another is to optimize plant growth in plant bags. Another is creating polymer balls to substitute soil this creates a new way to put the sun's energy at the root system of plants.

Further, the low thermal conductive textile may be used to manufacture one or more of cigarette filters, hot food delivery apparatuses, containers for plants, cigarette buds, wet-suits/jackets, hosiery, base layer garments, coated fabrics, camping tents, sleeping bags, head wear, gloves, scarves, dry-suits, home insulation, heat lags for industries, and automobile or motorcycle applications. Further, the low thermal conductive textile may be used in coatings mixed with microspheres. Further, the low thermal conductive textile may be constructed into films for barriers. Further, the low thermal conductive textile may be used to manufacture one or more of carrier textiles acrylic, PET, polypropylene, alginate, bamboo, Hemp, Polylactic Acid, rayon, nylon, Kevlar, Nomex, polyurethane, Modacrylic, spandex, etc.

Further, the present disclosure describes a method to facilitate the manufacture of a low thermal conductivity textile. Further, the method may include a step of sourcing manganese oxide in small particles. Further, the small particles may be associated with a particle size of not greater than 1 micron.

Further, the method may include a step of dry grinding the small particles of the manganese oxide. Further, the dry grinding may be a process of reducing particle size without using a liquid medium.

Further, the method may include a step of wet grinding and converting it into a lump. Further, the wet grinding may be a process of making the material into a liquid form (slurry) and reducing particles, such as agglomerates by shearing them down in size ranging from 100 nm to 600 nm.

Further, the method may include a step of capturing heat from a heat source. Further, the small particle size of the lump may facilitate capturing heat from the heat source. Further, the heat source may be the sun, a human body, or any ambient heat source.

Further, the method may include a step of analyzing the lump to determine a D100. Further, the D100 may be associated with a size of 1 micron.

Further, the method may include a step of choosing a polymer material. Further, the polymer material may include PET, cellulose, polylactic acid (PLA), Acrylic, Polypropylene, Nylon, Low-density polyethylene (LDPE), High-density polyethylene (HDPE), Polypropylene (PP), Polyvinyl chloride (PVC), Polystyrene (PS), Nylon, nylon 6, nylon 6,6, Teflon (Polytetrafluoroethylene), Thermoplastic polyurethanes (TPU), cellulose acetate (i.e. used in cigarette filters), etc.

Further, the method may include a step of initiating a masterbatch process. Further, the masterbatch process may generate a masterbatch. Further, the masterbatch may be a concentrated mixture of pigments and/or functional particles encapsulated during a heat process into a carrier resin which is then cooled and cut into a granular shape. Further, the masterbatch may allow the processor to add functional reactive particles to raw polymers economically during the plastic manufacturing process.

Further, the method may include a step of extruding the masterbatch into a hollow fiber membrane. Further, the hollow fiber membrane may be a class of artificial membranes containing a semi-permeable barrier in the form of a hollow fiber. During this process, the microparticles of manganese may be prevalent on the outside matrix of the hollow fiber creating a superior insulation matrix, as the air resides in the center of the hollow fiber and low conductive manganese oxide particles are on the outside of the hollow fiber.

Further, the present disclosure describes a “Suncycle” bag comprising a low thermal conductivity textile. Further, the “Suncycle” bag may be fabricated from the low conductive hollow fiber. Further, the “Suncycle” bag may include polymer balls to substitute soil, thereby putting the Sun's energy at the root system of plants. Further, a seed in a competitor bag does not show any progress.

Further, the present invention describes textiles. More specifically, the present disclosure describes methods to facilitate the fabrication of low thermal conductivity textiles.

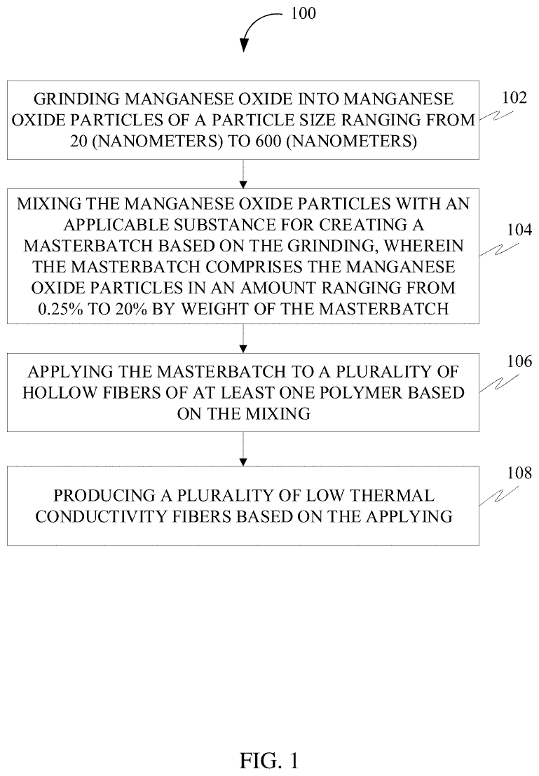

FIG. 1 is a flowchart of a method 100 for producing low thermal conductivity fibers for manufacturing low thermal conductivity textiles, in accordance with some embodiments. Further, at 102, the method 100 may include grinding manganese oxide into manganese oxide particles of a particle size ranging from 20 (nanometers) to 600 (nanometers).

Further, at 104, the method 100 may include mixing the manganese oxide particles with an applicable substance for creating a masterbatch based on the grinding. Further, the masterbatch may include the manganese oxide particles in an amount ranging from 0.25% to 20% by weight of the masterbatch.

Further, at 106, the method 100 may include applying the masterbatch to a plurality of hollow fibers of at least one polymer based on the mixing. Further, the at least one polymer may include PET, cellulose, polylactic acid (PLA), Acrylic, Polypropylene, Nylon, Low-density polyethylene (LDPE), High-density polyethylene (HDPE), Polypropylene (PP), Polyvinyl chloride (PVC), Polystyrene (PS), Nylon, nylon 6, nylon 6,6, Teflon (Polytetrafluoroethylene), Thermoplastic polyurethanes (TPU), cellulose acetate (i.e. used in cigarette filters), etc.

Further, at 108, the method 100 may include producing a plurality of low thermal conductivity fibers based on the applying. Further, the plurality of low thermal conductivity fibers has low thermal conductivity. Further, the low thermal conductivity textiles may be manufactured using the plurality of low thermal conductivity fibers.

Further, in some embodiments, the applying may include extruding the masterbatch into each of the plurality of hollow fibers for depositing the manganese oxide particles on an outer portion of the each of the plurality of hollow fibers based on the mixing. Further, the producing of the plurality of low thermal conductivity fibers may be based on the extruding.

Further, in some embodiments, the applying may include spray coating the masterbatch on an outer surface of each of the plurality of hollow fibers for depositing the manganese oxide particles on an outer portion of the each of the plurality of hollow fibers based on the mixing. Further, the producing of the plurality of low thermal conductivity fibers may be based on the spray coating.

Further, in some embodiments, the applying may include plasma depositing the masterbatch on an outer surface of each of the plurality of hollow fibers for depositing the manganese oxide particles on an outer portion of the each of the plurality of hollow fibers based on the mixing. Further, the producing of the plurality of low thermal conductivity fibers may be based on the plasma depositing.

Further, in some embodiments, the masterbatch may include the manganese oxide particles in an amount ranging from 1% to 20% by weight of the masterbatch.

Further, in some embodiments, the masterbatch may include the manganese oxide particles in an amount ranging from 0.25% to 1% by weight of the masterbatch.

Further, in some embodiments, the applicable substance may include a water-resistant substance.

Further, in some embodiments, the plurality of low thermal conductivity fibers may include the manganese oxide particles in an outer portion of each of the plurality of low thermal conductivity fibers based on the applying and air in an interior hollow space of the each of the plurality of low thermal conductivity fibers for making the plurality of low thermal conductivity fibers thermally insulated.

Further, in some embodiments, the applying of the masterbatch to the plurality of hollow fibers may include inserting the manganese oxide particles in a first side of an outer portion of each of the plurality of hollow fibers. Further, the producing of the plurality of low thermal conductivity fibers may be based on the inserting of the manganese oxide particles. Further, the method 100 may include inserting thermally conductive material particles to a second side of the outer portion of the each of the plurality of hollow fibers. Further, the producing of the plurality of low thermal conductivity fibers may be based on the inserting of the thermally conductive material particles. Further, in an embodiment, the thermally conductive material particles may include at least one of metallic particles and non-metallic particles. Further, the metallic particles may include metals such as aluminum, silver, gold, platinum, copper, etc. Further, in an embodiment, the thermally conductive material particles comprised in the second side of the outer portion of the each of the plurality of hollow fibers allows conducting the heat along the second side of the each of the plurality of hollow fibers for preventing concentrated heating of a specific portion of the low thermal conductivity textiles. Further, the manganese oxide particles comprised in the first side of the outer portion of each of the plurality of hollow fibers do not allow conducting of the heat for preventing transferring the heat from the first side to the second side.

Further, in an embodiment, the first side of the outer portion of each of the plurality of hollow fibers forms an outer surface of the low thermal conductivity textiles and the second side of the outer portion of the each of the plurality of hollow fibers forms an inner surface of the low thermal conductivity textiles.

Further, in an embodiment, the first side of the outer portion of each of the plurality of hollow fibers forms the inner surface of the low thermal conductivity textiles and the second side of the outer portion of the each of the plurality of hollow fibers forms the outer surface of the low thermal conductivity textiles

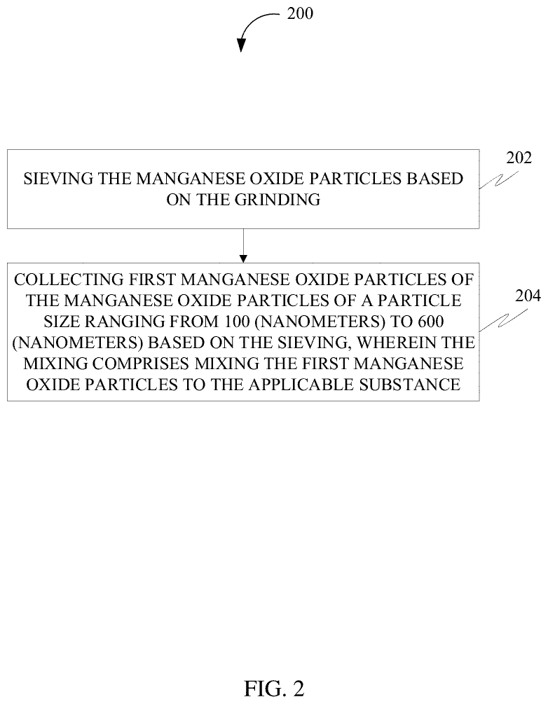

FIG. 2 is a flowchart of a method 200 for collecting first manganese oxide particles from the manganese oxide particles for producing the low thermal conductivity fibers, in accordance with some embodiments. Further, at 202, the method 200 may include sieving the manganese oxide particles based on the grinding.

Further, at 204, the method 200 may include collecting the first manganese oxide particles of the manganese oxide particles of a particle size ranging from 100 (nanometers) to 600 (nanometers) based on the sieving. Further, the mixing may include mixing the first manganese oxide particles to the applicable substance.

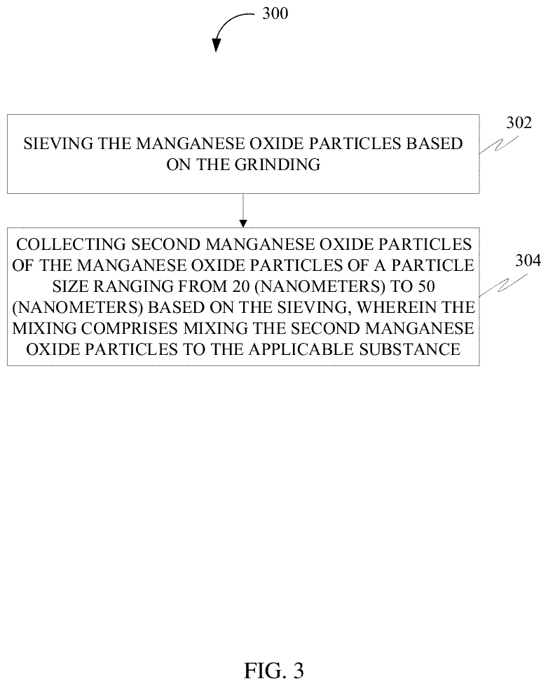

FIG. 3 is a flowchart of a method 300 for collecting second manganese oxide particles from the manganese oxide particles for producing the low thermal conductivity fibers, in accordance with some embodiments. Further, at 302, the method 300 may include sieving the manganese oxide particles based on the grinding.

Further, at 304, the method 300 may include collecting the second manganese oxide particles of the manganese oxide particles of a particle size ranging from 20 (nanometers) to 50 (nanometers) based on the sieving. Further, the mixing may include mixing the second manganese oxide particles to the applicable substance.

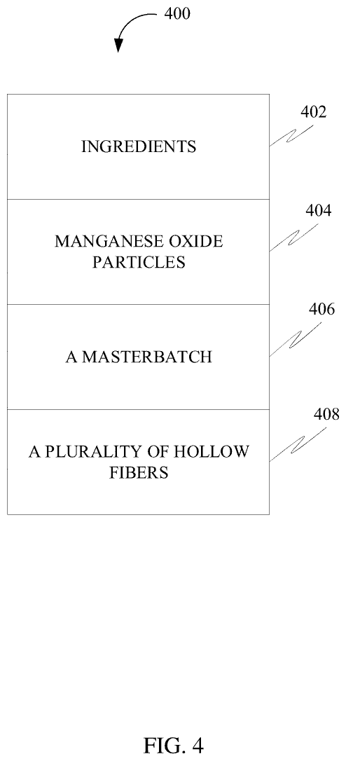

FIG. 4 is a table 400 listing ingredients of a low thermal conductivity fibers composition for manufacturing low thermal conductivity textiles, in accordance with some embodiments. Further, the table 400 may include a column 402 and three rows 404-408. Further, the table 400 may include three cells (column 402, row 404), (column 402, row 406), and (column 402, row 408). Further, the low thermal conductivity fibers composition may include manganese oxide particles, a masterbatch, and a plurality of hollow fibers.

Further, a cell (column 402, row 404) of the table 400 may be related to the manganese oxide particles. Further, the manganese oxide particles may be of a particle size ranging from 20 (nanometers) to 600 (nanometers).

Further, a cell (column 402, row 406) of the table 400 may be related to the masterbatch. Further, the masterbatch may include the manganese oxide particles and an applicable substance. Further, the masterbatch may include the manganese oxide particles in an amount ranging from 0.25% to 20% by weight of the masterbatch

Further, a cell (column 402, row 408) of the table 400 may be related to the plurality of hollow fibers. Further, the plurality of hollow fibers may be of at least one polymer.

Further, in some embodiments, the masterbatch may include the manganese oxide particles in an amount ranging from 1% to 20% by weight of the masterbatch.

Further, in some embodiments, the masterbatch may include the manganese oxide particles in an amount ranging from 0.25% to 1% by weight of the masterbatch.

Further, in some embodiments, the applicable substance may include a water-resistant substance.

Further, in some embodiments, the manganese oxide particles may include first manganese oxide particles of a particle size ranging from 100 (nanometers) to 600 (nanometers).

Further, in some embodiments, the manganese oxide particles may include second manganese oxide particles of a particle size ranging from 20 (nanometers) to 50 (nanometers).

In further embodiments, the low thermal conductivity fibers composition may further include thermally conductive material particles. Further, in an embodiment, the thermally conductive material particles may include at least one of metallic particles and non-metallic particles.

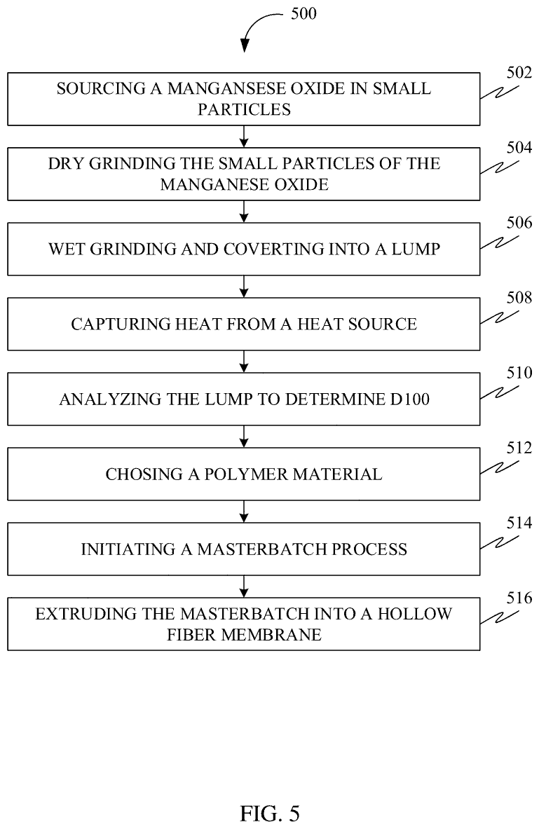

FIG. 5 is a flowchart of a method 500 to facilitate manufacturing of a, in accordance with some embodiments. Accordingly, at 502, the method 500 may include a step of sourcing a manganese oxide in small particles. Further, the small particles may be associated with a particle size of not greater than 1 micron.

Further, at 504, the method 500 may include a step of dry grinding the small particles of the manganese oxide. Further, the dry grinding may be a process of reducing particle size without using a liquid medium.

Further, at 506, the method 500 may include a step of wet grinding and converting it into a lump. Further, the wet grinding may be a process of making the material into a liquid form (slurry) and reducing particles, such as agglomerates by shearing them down in size ranging from 100 nm to 600 nm.

Further, at 508, the method 500 may include a step of capturing heat from a heat source. Further, the small particle size of the lump may facilitate capturing heat from the heat source. Further, the heat source may be the sun, a human body, or any ambient heat source.

Further, at 510, the method 500 may include a step of analyzing the lump to determine a D100. Further, the D100 may be associated with a size of 1 micron.

Further, at 512, the method 500 may include a step of choosing a polymer material. Further, the polymer material may include PET, cellulose, polylactic acid (PLA), Acrylic, Polypropylene, Nylon, Low-density polyethylene (LDPE), High-density polyethylene (HDPE), Polypropylene (PP), Polyvinyl chloride (PVC), Polystyrene (PS), Nylon, nylon 6, nylon 6,6, Teflon (Polytetrafluoroethylene), Thermoplastic polyurethanes (TPU), cellulose acetate (i.e. used in cigarette filters), etc.

Further, at 514, the method 500 may include a step of initiating a masterbatch process. Further, the masterbatch process may generate a masterbatch. Further, the masterbatch may be a concentrated mixture of pigments and/or functional particles encapsulated during a heat process into a carrier resin which is then cooled and cut into a granular shape. Further, the masterbatch may allow the processor to add functional reactive particles to raw polymers economically during the plastic manufacturing process.

Further, at 516, the method 500 may include a step of extruding the masterbatch into a hollow fiber membrane. Further, the hollow fiber membrane may be a class of artificial membranes containing a semi-permeable barrier in the form of a hollow fiber. During this process, the micro particles of manganese may be prevalent on the outside matrix of the hollow fiber creating a superior insulation matrix, as the air resides in the center of the hollow fiber and low conductive manganese oxide particles are on the outside of the hollow fiber.

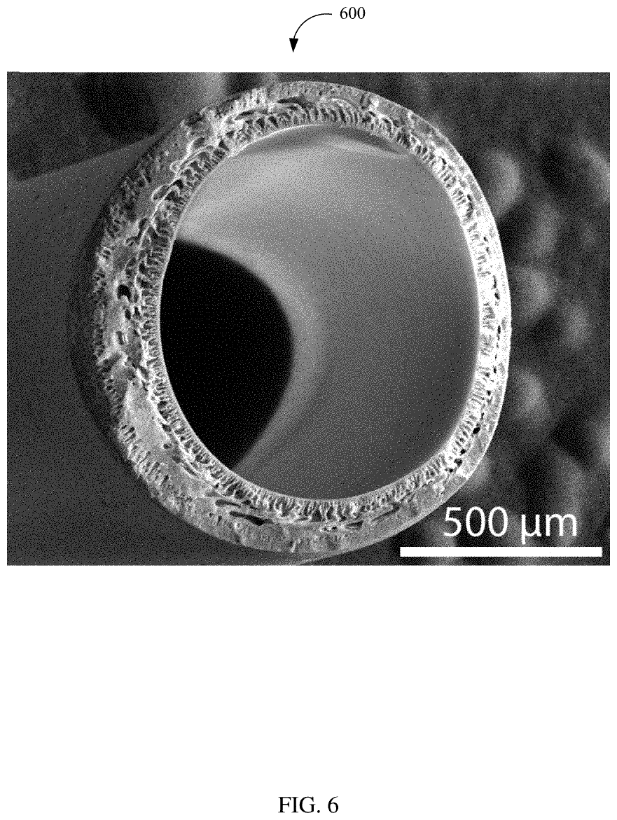

FIG. 6 is a close-up view of a hollow fiber 600 of the plurality of hollow fibers.

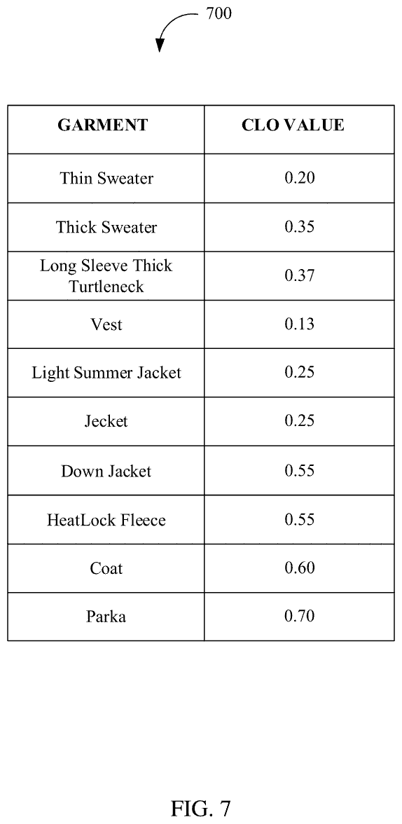

FIG. 7 illustrates a chart 700 showing CLO Values from SGS testing company for Heatlock Polar Fleece fabric, in accordance with some embodiments. Further, the Heatlock Polar Fleece fabric may be the low thermal conductivity textiles. Further, the Heatlock Polar Fleece fabric may be composed of 100% Heatlock embedded polyester filament. Further, the Heatlock Polar Fleece fabric may be associated with a charcoal color. Further, a do test may demonstrate the warmth value of the Heatlock Polar Fleece fabric. Further, the do test may be associated with test conditions. Further, the test conditions may include an air temperature of 20.0±0.1° C., a relative humidity of 65±3%, an airspeed of 1.0±0.05 m/s, and a temperature of hotplate of 35.0±0.1° C. Further, the test conditions may include an orientation of a test specimen. Further, the orientation of the test specimen may include specimen lied flat across the measurement unit with the side normally facing the human body towards the measuring unit. Further, the Heatlock Polar Fleece fabric backside (skin contact side) is in contact with a hotplate. Further, the Heatlock Polar Fleece fabric may be associated with a mean thermal resistance of 0.0853 m²K/W.

Further, the Heatlock Polar Fleece fabric may be associated with a do value of 0.55. Further, the do value measures how fast heat travels from one side of the hollow fiber to another. Further, the new insulation of the Heatlock Polar Fleece fabric is lighter and warmer as demonstrated with the do test. The 250 gsm is as warm as a down jacket.

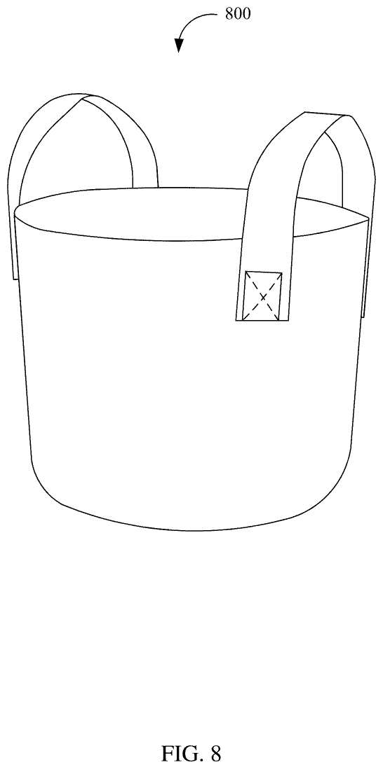

FIG. 8 is a perspective view of a container 800 for plants comprising the low thermal conductivity textiles, in accordance with an exemplary embodiment. Further, the container 800 may be fabricated from the low thermal conductivity textiles that may assist in the growth of plants in the container 800.

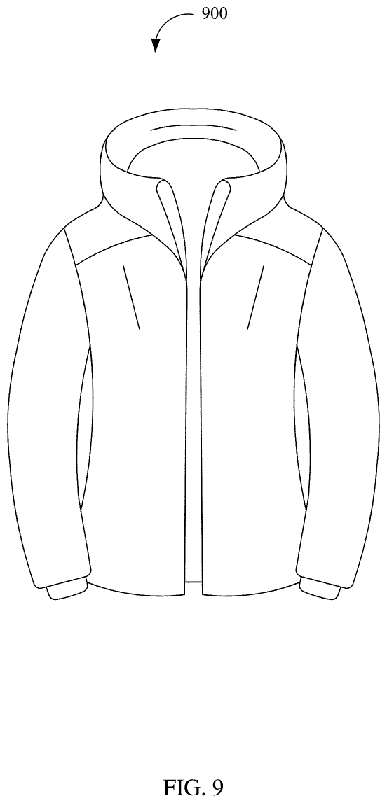

FIG. 9 is a front view of a jacket 900 comprising the low thermal conductivity textiles, in accordance with an exemplary embodiment. Further, the jacket 900 may be fabricated from the low thermal conductivity textiles to prevent the heat loss from the body of an individual wearing the jacket 900.

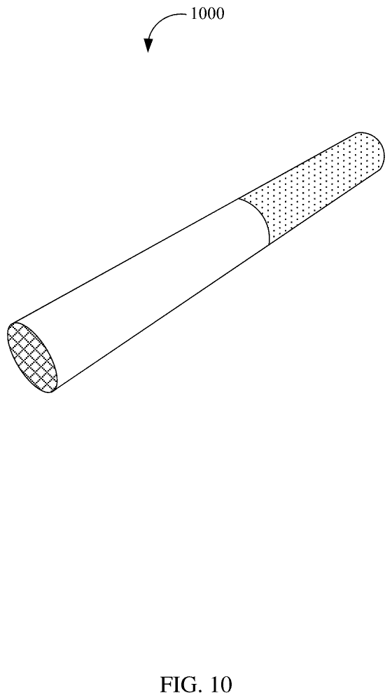

FIG. 10 is a perspective view of a cigarette 1000 comprising the low thermal conductivity textiles, in accordance with an exemplary embodiment. Further, the cigarette 1000 may include a cigarette bud. Further, the cigarette bud may be the tail end of the cigarette 1000. Further, the cigarette bud may be built from the low thermal conductivity textiles. Further, the low thermal conductivity textiles may prevent transferring of heat from the cigarette bud to at least one of fingers and lips of an individual smoking the cigarette 1000.

Although the present disclosure has been explained in relation to its preferred embodiment, it is to be understood that many other possible modifications and variations can be made without departing from the spirit and scope of the disclosure.

What is claimed is:

1. A method for producing low thermal conductivity fibers for manufacturing low thermal conductivity textiles, the method comprising:
grinding manganese oxide into manganese oxide particles of a particle size ranging from 20 (nanometers) to 600 (nanometers);
mixing the manganese oxide particles with an applicable substance for creating a masterbatch based on the grinding, wherein the masterbatch comprises the manganese oxide particles in an amount ranging from 0.25% to 20% by weight of the masterbatch;
applying the masterbatch to a plurality of hollow fibers of at least one polymer based on the mixing; and
producing a plurality of low thermal conductivity fibers based on the applying, wherein the low thermal conductivity textiles are manufactured using the plurality of low thermal conductivity fibers.

2. The method of claim 1, wherein the applying comprises extruding the masterbatch into each of the plurality of hollow fibers for depositing the manganese oxide particles on an outer portion of the each of the plurality of hollow fibers based on the mixing, wherein the producing of the plurality of low thermal conductivity fibers is based on the extruding.

3. The method of claim 1, wherein the applying comprises spray coating the masterbatch on an outer surface of each of the plurality of hollow fibers for depositing the manganese oxide particles on an outer portion of the each of the plurality of hollow fibers based on the mixing, wherein the producing of the plurality of low thermal conductivity fibers is based on the spray coating.

4. The method of claim 1, wherein the applying comprises plasma depositing the masterbatch on an outer surface of each of the plurality of hollow fibers for depositing the manganese oxide particles on an outer portion of the each of the plurality of hollow fibers based on the mixing, wherein the producing of the plurality of low thermal conductivity fibers is based on the plasma depositing.

5. The method of claim 1, wherein the masterbatch comprises the manganese oxide particles in an amount ranging from 1% to 20% by weight of the masterbatch.

6. The method of claim 1, wherein the masterbatch comprises the manganese oxide particles in an amount ranging from 0.25% to 1% by weight of the masterbatch.

7. The method of claim 1, wherein the applicable substance comprises a water-resistant substance.

8. The method of claim 1 further comprising:
sieving the manganese oxide particles based on the grinding; and
collecting first manganese oxide particles of the manganese oxide particles of a particle size ranging from 100 (nanometers) to 600 (nanometers) based on the sieving, wherein the mixing comprises mixing the first manganese oxide particles to the applicable substance.

9. The method of claim 1 further comprising:
sieving the manganese oxide particles based on the grinding; and
collecting second manganese oxide particles of the manganese oxide particles of a particle size ranging from 20 (nanometers) to 50 (nanometers) based on the sieving, wherein the mixing comprises mixing the second manganese oxide particles to the applicable substance.

10. The method of claim 1, wherein the plurality of low thermal conductivity fibers comprises the manganese oxide particles in an outer portion of each of the plurality of low thermal conductivity fibers based on the applying and air in an interior hollow space of the each of the plurality of low thermal conductivity fibers for making the plurality of low thermal conductivity fibers thermally insulated.

11. The method of claim 1, wherein the applying of the masterbatch to the plurality of hollow fibers comprises inserting the manganese oxide particles in a first side of an outer portion of each of the plurality of hollow fibers, wherein the producing of the plurality of low thermal conductivity fibers is based on the inserting of the manganese oxide particles, wherein the method further comprises inserting thermally conductive material particles to a second side of the outer portion of the each of the plurality of hollow fibers, wherein the producing of the plurality of low thermal conductivity fibers is further based on the inserting of the thermally conductive material particles.

12. The method of claim 11, wherein the thermally conductive material particles comprise at least one of metallic particles and non-metallic particles.

13. A low thermal conductivity fibers composition for manufacturing low thermal conductivity textiles, the low thermal conductivity fibers composition comprising:
manganese oxide particles of a particle size ranging from 20 (nanometers) to 600 (nanometers);
a masterbatch comprising the manganese oxide particles and an applicable substance, wherein the masterbatch comprises the manganese oxide particles in an amount ranging from 0.25% to 20% by weight of the masterbatch; and
a plurality of hollow fibers of at least one polymer.

14. The low thermal conductivity fibers composition of claim 13, wherein the masterbatch comprises the manganese oxide particles in an amount ranging from 1% to 20% by weight of the masterbatch.

15. The low thermal conductivity fibers composition of claim 13, wherein the masterbatch comprises the manganese oxide particles in an amount ranging from 0.25% to 1% by weight of the masterbatch.

16. The low thermal conductivity fibers composition of claim 13, wherein the applicable substance comprises a water-resistant substance.

17. The low thermal conductivity fibers composition of claim 13, wherein the manganese oxide particles comprises first manganese oxide particles of a particle size ranging from 100 (nanometers) to 600 (nanometers).

18. The low thermal conductivity fibers composition of claim 13, wherein the manganese oxide particles comprises second manganese oxide particles of a particle size ranging from 20 (nanometers) to 50 (nanometers).

19. The low thermal conductivity fibers composition of claim 13 further comprising thermally conductive material particles.

20. The low thermal conductivity fibers composition of claim 19, wherein the thermally conductive material particles comprise at least one of metallic particles and non-metallic particles.
